(19) United States
(12) Patent Application Publication
(10) Pub. No.: US 2003/0235127 A1
(43) Pub. Date: Dec. 25, 2003

(54) Optical pickup having a monitor photodetector

(75) Inventors: Dong-Ryeol Lee, Seoul (KR); Yong-Jun Cho, Gyeonggi-do (KR); Pyong-Yong Seong, Seoul (KR); Young-Kug Yoon, Gyeonggi-do (KR); Kun-Soo Kim, Seoul (KR); Sun-Mook Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-city (KR)

(21) Appl. No.: 10/464,770

(22) Filed: Jun. 19, 2003

(30) Foreign Application Priority Data
Jun. 20, 2002 (KR) 2002-34645

(51) Int. Cl. G11B 7/125; G11B 7/135

(52) U.S. Cl. 369/53.26; 369/112.16

(57) ABSTRACT

An optical pickup to focus a light emitted from a light source using an objective lens, forming a light spot on a recording surface of a recording medium, and performing recording and/or reproducing operations using the light. The optical pickup includes a monitor photodetector and an optical element installed in front of the monitor photodetector to receive and to detect a portion of the light emitted from the light source to control an amount of light power output from the light source and to adjust at least one of an intensity, a beam profile, and a proceeding direction of the light incident on the monitor photodetector.

This application claims the priority of Korean Patent Application No. 2002-34645, filed on Jun. 20, 2002, in the Korean Intellectual Property Office, the disclosure of which is incorporated herein in its entirety by reference.

### BACKGROUND OF THE INVENTION

1. Field of the Invention

The present invention relates to an optical pickup, and more particularly, to an optical pickup having a monitor photodetector for controlling an amount of light power output from a light source.

2. Description of the Related Art

Recording apparatuses used for CD-family optical discs (hereinafter referred to as CDs) or DVD-family optical discs (hereafter referred to as DVDs), focus laser light beams emitted from a laser diode, which is a light source of an optical pickup, onto an optical disc using an objective lens to record data on the optical disc. For exact recording, such a recording apparatus needs to maintain a proper amount of light power and needs to adjust an output of the light source to a write-strategy, which is an algorithm for recording.

A component used in the optical pickup to control the output of the light source is a monitor photodetector (also called a front photodetector).

In general, the optical pickup splits the light beams incident on the objective lens using a beam splitter, allows the split of the light beams to be incident on the monitor photodetector, and controls the amount of the light power emitted from the light source used for a CD or a DVD using an intensity of the light incident on the monitor photodetector.

The monitor photodetector is connected to an amplifying circuit so that a current signal, which is generated in proportion to the intensity of the light received by opto-electronic conversion and output, is amplified by a predetermined gain. In other words, the photodetector is set to have a specific gain.

Accordingly, in a case where one monitor photodetector is used to control the amount of the light powers output from a plurality of light sources of the optical pickup, costs for manufacturing the optical pickup can be reduced and the optical pickup can be easily arranged in a small space. However, for the following reasons, it is difficult to simultaneously control the light powers output from the light source used for the CD and the light source used for the DVD by using one monitor photodetector.

Because the light power for the CD is greatly different from the light power for the DVD, when the monitor photodetector is set to have a constant gain, it is difficult to fully secure a dynamic range in which the intensity of the light emitted from the light source used for the CD and the intensity of light emitted from the light source used for the DVD can be detected. For example, because a recording light power for the CD is greatly different from a recording light power for the DVD, the intensity of the light incident on the monitor photodetector when recording data on the CD is greatly different from the intensity of the light incident on the monitor photodetector when recording the data on the DVD. Thus, the amount of the light power for the CD and the amount of the light power for the DVD may get out of the detectable range of the monitor photodetector. As a result, controlling the amount of the light power is difficult so that recording light powers for the CD and the DVD are obtained.

Also, the higher a speed factor, the greater recording of the light power the recording apparatus requires. Therefore, when the intensity of the light incident on the objective lens is adjusted to satisfy the light power requirements of high speed recording, the intensity of light incident on the monitor photodetector may be less or may be greater in comparison with the gain of the monitor photodetector.

Moreover, because the light beam emitted from the light source, i.e., a semiconductor laser, and proceeding toward the monitor photodetector has a Gaussian beam profile and a size of an effective light receiving area of the monitor photodetector is smaller than a size of the light beam formed on the monitor photodetector, the intensity of the light incident on the monitor photodetector is greatly affected by shifting or tilting of an optical component, particularly the light source, during the controlling of high-speed recording. As a result, it is difficult to properly control the amount of the light power. In other words, because the effective light receiving area of the monitor photodetector is smaller than the size of the incident light beam, the detection signal may greatly vary due to tilting of the incident light beam.

### SUMMARY OF THE INVENTION

According to an aspect of the present invention, there is provided an optical pickup to properly control a light power output from a light source.

According to an aspect of the present invention, there is provided an optical pickup focusing a light emitted from a light source using an objective lens, forming a light spot on a recording surface of a recording medium, and performing recording and/or reproducing operations using the light. The optical pickup includes an optical element that is installed in front of a monitor photodector to receive and detect a portion of the light emitted from the light source to control an amount of light power output from the light source and to adjust at least one of an intensity, a beam profile, and a proceeding direction of the light incident on the monitor photodector.

The optical element may be a holographic element.

The optical element may be formed so as to reduce an intensity of the incident light. The light source may include a plurality of light sources emitting light beams of different wavelengths, and a transmissivity of the optical element may vary according to a wavelength of the incident light.

The optical element may adjust divergence and convergence of the incident light.

The optical element may shape the incident light.

The optical element may adjust a direction of a +1^{st}- or −1^{st}- order beam.

According to an aspect of the present invention, a portion of light emitted from the light source is split by an optical path changing unit, and then the light split proceeds toward the monitor photodetector.

The optical path changing unit may be a cubic beam splitter, a plate beam splitter, or a wedge beam splitter.

The optical element may form a single body with the optical path changing unit or may be separate from the optical path changing unit.

The recording medium may be a CD-family optical disc and/or a DVD-family optical disc.

According to an aspect of the present invention, there is provided an optical pickup for a recording medium, including a light source emitting light beams; an objective lens focusing the light beams to form a light spot on a recording surface of a recording medium; a main photodetector receiving the light beams reflected from the recording surface of the recording medium to detect a data signal and/or an error signal; a monitor photodetector controlling an amount of light power output from the light source; and an optical element controlling at least one of an intensity, a beam profile, and a proceeding direction of a light incident on the monitor photodetector.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and/or advantages of the invention will become apparent and more readily appreciated from the following description of the aspects of the present invention, taken in conjunction with the accompanying drawings of which:

FIG. 1 is a schematic view of an optical pickup, according to an aspect of the present invention;

FIG. 2 is a schematic view of the optical pickup using a plate beam splitter as an optical path changing unit, according to an aspect of the present invention;

FIG. 3 is a schematic view of the optical pickup using a wedge beam splitter as the optical path changing unit, according to another aspect of the present invention;

FIG. 4 is a schematic plan view of a hologram pattern of a holographic element serving as a lens for diverging or converging incident light beams;

FIG. 5 is a plan view of the hologram pattern of the holographic element capable of shaping incident light beams; and

FIG. 6 is a plan view of the hologram pattern of the holographic element capable of adjusting a direction of a +1^{st}- or −1^{st}-order beam.

### DETAILED DESCRIPTION OF THE INVENTION

Reference will now be made in detail to aspects of the present invention, examples of which are illustrated in the accompanying drawings, wherein like reference numerals refer to like elements throughout. The aspects are described below in order to explain the present invention by referring to the figures.

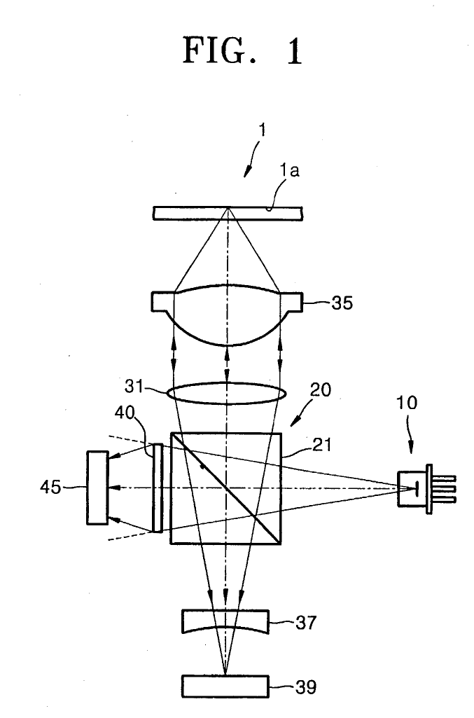

FIG. 1 shows an optical structure of an optical pickup, according to an aspect of the present invention. Referring to FIG. 1, the optical pickup includes a light source 10, an objective lens 35, an optical path changing unit 20, a main photodetector 39, a monitor photodetector 45, and an optical element 40. The objective lens 35 focuses light beams emitted from the light source 10 to form a light spot on a recording surface 1a of a recording medium 1. The optical path changing unit 20 changes proceeding paths of incident light beams. The main photodetector 39 receives the light beams reflected from the recording surface 1a of the recording medium 1 to detect a data signal and/or an error signal. The monitor photodetector 45 controls the amount of the light power output from the light source 10. The optical element 40 is installed in front of the monitor photodetector 45.

The light source 10 may be a single light source or two light sources that emit light beams having different wavelengths.

For example, the optical pickup, according to an aspect of the present invention, may use the single light source that emits the light beam with a wavelength of 650 nm as the light source 10, so that the optical pickup is used only for DVDs or is compatible with DVDs and CDs, i.e., the optical pickup is used to record data on and/or reproduce data from the DVD and to reproduce data from the CD. The optical pickup, according to an aspect of the present invention, may also use the single light source that emits the light beam with a wavelength of 780 nm as the light source 10, so that the optical pickup is used to record the data on and/or to reproduce the data from the CD. Alternatively, the optical pickup may include two light sources that emit the light beam with a wavelength of 780 nm suitable for the CD, and the light beam with the wavelength of 650 nm suitable for the DVD, respectively, so that the optical pickup is used to reproduce the data from the DVD and record the data on and/or reproduce the data from the CD, or to record the data on and/or reproduce the data from the DVD and the CD.

In the event that the light source 10 is two light sources, the optical pickup may include a light source module (referred to as a TWIN-LD) having a package in which the two light sources, respectively, emitting the light beam having the 650 nm wavelength suitable for the DVD and the light beam having the 780 nm wavelength suitable for the CD form a single body. However, the light source 10 may be two separate light sources. In this case, the optical pickup may further include an optical path changing unit (not shown), which allows any light beam emitted from the two light sources to be incident on the optical path changing unit 20.

The optical path changing unit 20 allows the light beams emitted from the light source 10 to proceed toward the recording medium 1, changes optical paths of the light beams reflected from the recording medium 1 so that the reflected light beams proceed toward the main photodetector 39, and splits a portion of light beams emitted from the light source 10 so that split light beams proceed toward the monitor photodetector 45.

For example, as shown in FIG. 1, the optical path changing unit 20 reflects light beams emitted from the light source 10 toward the recording medium 1, transmits the light beams reflected from the recording medium 1 toward the main photodetector 39, and transmits a portion of the light beams emitted from the light source 10 toward the monitor photodetector 45 that is installed at a side of the optical path changing unit 20.

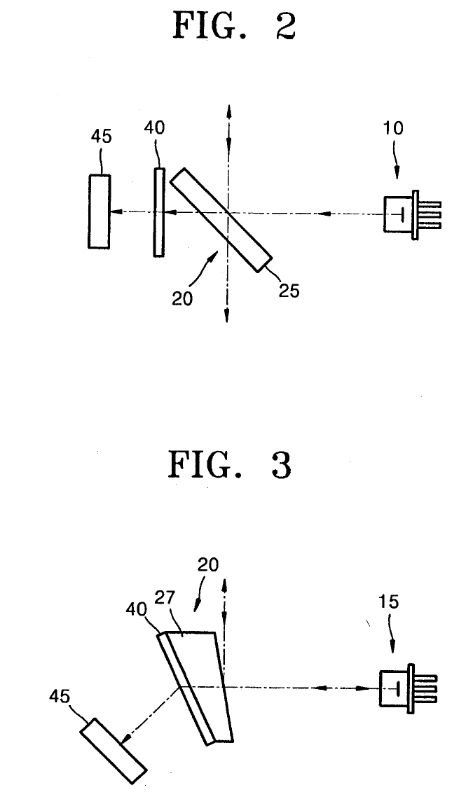

As shown in FIG. 1, the optical path changing unit 20 may be a cubic beam splitter 21. Alternatively, as shown in FIGS. 2 and 3, the optical path changing unit 20 may be a plate beam splitter 25 or a wedge beam splitter 27.

Referring to FIG. 3, when the wedge beam splitter 27 is used as the optical path changing unit 20, the optical pickup may include a holographic optical module 15 in which the light source 10 and the main photodetector 39 are modularized. In other words, as shown in FIG. 1, instead of the light source 10 and the main photodetector 29 being separate units, a 650 nm holographic optical module and/or a 780 nm holographic optical module may be included. Here, the holographic optical module 15 is well-known in the art, and thus will not be described herein.

The monitor photodetector 45 is disposed at the side of the optical path changing unit 20 so that the monitor photodetector 45 receives and detects the portion of light beams emitted from the light source 10. A detection signal of the monitor photodetector 45 is fed back to a driver, which drives the light source 10 and is used to control the amount of the light power of the light source 10.

The optical element 40 may adjust at least one of an intensity, a beam profile, and a proceeding direction of the light beam incident on the monitor photodetector 45. The optical element 40 may be a holographic element.

In the optical pickup, according to an aspect of the present invention, the optical element 40 may form a single body with the optical path changing unit 20 or may be separate from the optical path changing unit 20.

In FIG. 1, reference numeral 31 denotes a collimating lens that changes the divergent light beams emitted from the light source 10 into parallel light beams, and reference numeral 37 denotes a sensing lens that enlarges the size of the light spot formed on the main photodetector 39. In a case where the optical pickup, according to an aspect of the preset invention, detects a focus error signal according to an astigmatic method, the sensing lens 37 may operate as an astigmatic lens.

Hereinafter, various aspects of the optical element 40 will be described.

For example, in a case where the optical pickup, according to an aspect of the present invention, includes the two light sources emitting the light beams of different wavelengths, i.e., the light source used for the DVDs and the light source used for the CDs, as the light source 10, a transmissivity of the optical element 40 may be different for the light beam used for the CD and the light beam used for the DVD.

In this case, even when a gain of the monitor photodetector 45 is constant, the amount of light powers necessary for the CDs and the DVDs can be properly controlled. In other words, in a case where the optical pickup, according to an aspect of the present invention, is used to record the data on and/or reproduce the data from the CDs and DVDs, an amount of recording light power used for the DVDs is greater than the amount of the recording light power used for the CDs. Thus, if the optical element 40 has a low transmissivity for the light beam used for the DVD and a higher transmissivity for the light beam used for the CD, the intensities of the light beams used for the CD and the DVD received by the monitor photodetector 45 can be within a detectable range. Thus, the recording light powers of the light sources for the DVD and the CD can be properly controlled.

As described above, in the event that the two light sources emitting the light beams of different wavelengths are included and the optical element 40 has different transmissivities of the light beams according to corresponding wavelengths so that the amounts of light power output from the two light sources are properly controlled by the monitor photodetector 45, the optical pickup, according to an aspect of the present invention, can record the data on the relatively low-density recoding medium, i.e., the CD, and the relatively high-density recording medium, i.e., the DVD.

Here, the transmissivity according to the wavelength of the incident light beam can be adjusted by forming a stepped hologram pattern of the holographic element with a corresponding height properly designed. It is well known in the technical field of holographic elements that the light transmissivity of the holographic element depends on the height and a number of steps of a stepped hologram pattern and that the transmissivity of the holographic element depends on the wavelength of incident light. Therefore, the details of this art will not be described or shown herein.

Regardless of whether the light source 10 is the single light source or the two light sources, if the monitor photodetector 45 controls only the amount of the light power output from one light source at a time and the optical element 40 adjusts the intensity of the light proceeding toward the monitor photodetector 45, the light power output from the light source 10 can be properly controlled during high-speed recording without changing specifications of the optical path changing unit 20.

In other words, because the beam splitter 21 or 25 used as the optical path changing unit 20 has a quite high transmissivity so as to reflect the light emitted from the light source 10 toward the recording medium 1 and transmit the light reflected from the recording medium 1 toward the main photodetector 39, the intensity of the light going toward the monitor photodetector 45 via the optical path changing unit 20 is large.

Accordingly, if the gain of the monitor photodetector 45 is set so that the light power output from the light source 10 can be detected during the low-speed recording, the light power output from the light source 10 may be increased for the high-speed recording. Then, light of an intensity getting out of a detectable range is incident on the monitor photodetector 45, and, thus, it is difficult to properly detect the amount of the light power output from the light source 10.

However, as in an aspect of the present invention, when the optical element 40 is installed between the optical path changing unit 20 and the monitor photodetector 45 in order to adjust (finally reduce) the intensity of light proceeding toward the monitor photodetector 45, the amount of the light power output from the light source 10 can be properly controlled during the high-speed recording without changing specifications of the optical path changing unit 20.

In the optical pickup, according to an aspect of the present invention, as previously described, the optical element 40 may be formed so as to adjust a beam profile and a proceeding direction of the incident light.

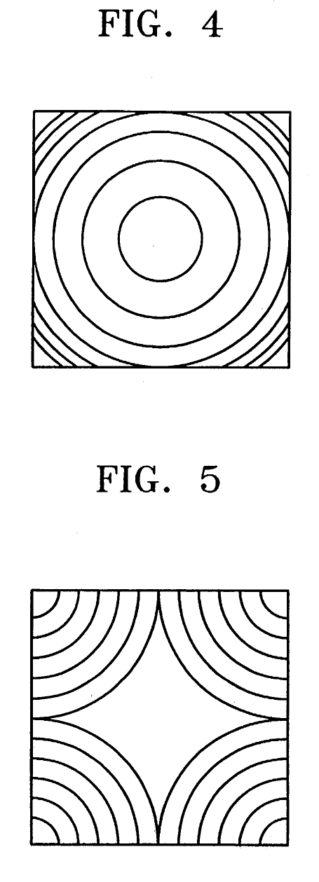

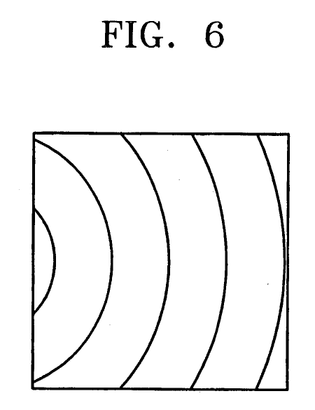

FIGS. 4 through 6 are views of aspects of the hologram patterns of the holographic element, which may be used as the optical element 40, in the optical pickup, according to an aspect of the present invention. FIG. 4 schematically illustrates the hologram pattern of a holographic element that operates as a lens to transmit or converge the incident light. FIG. 5 schematically illustrates the hologram pattern of a holographic element capable of shaping the incident light beams. FIG. 6 schematically illustrates a hologram pattern of the holographic element to adjust a direction of a +1^{st}- or −1^{st}-order beam.

When the holographic element having the hologram pattern and capable of operating as the lens as shown in FIG. 4 is used as the optical element 40, the size of the light beam proceeding toward the monitor photodetector 45 can be reduced compared to the prior art so that the monitor photodetector 45 can receive the light having a sufficient intensity. FIG. 1 illustrates an example of reducing the size of the light beam using the optical element 40.

As described above, when the size of the light beam proceeding toward the monitor photodetector 45 is reduced, even if an optical component, particularly the light source 10, is shifted or tilted during the controlling of the high-speed recording, the intensity of the light received by the monitor photodetector 45 barely varies. Thus, the amount of the light power output from the light source 10 can be properly controlled.

As shown in FIG. 5, when the holographic element having the hologram pattern capable of shaping the light beam is used as the optical element 40, the light received by the monitor photodetector 45 is shaped by the holographic element, and, thus, shows a beam profile in which the intensity distribution is nearly uniform. Therefore, because the intensity of the light received by the monitor photodetector 45 is not greatly affected by shifting or tilting of the optical component, particularly, the light source 10, during controlling of the high-speed recording, the light power output from the light source 10 can be properly controlled.

Here, the holographic element having the hologram pattern in which the hologram patterns shown in FIGS. 4 and 5 are blended, may be used as the optical element 40.

As described with reference to FIGS. 4 and 5, when the optical element 40, which adjusts the beam profile by adjusting the divergence and the convergence of the incident light and by shaping the light beam, is included, the intensity of the light received by the monitor photodetector 45 is not greatly affected by the shifting or tilting of the optical component, particularly the light source 10, during the controlling of the high-speed recording. Thus, the light power output from the light source 10 can be properly controlled.

As shown in FIG. 6, when the holographic element having the hologram pattern capable of tilting the proceeding direction of the diffracted beam is used as the optical element 40, the monitor photodetector 45 can be disposed correspondingly to a restriction in a space of a slim type, which is advantageous in creating a slim optical pickup structure.

As described above, the optical element 40 used in an optical pickup, according to an aspect of the present invention, is formed so as to perform at least one of a function of adjusting the intensity of an incident light and functions of adjusting a beam profile and a proceeding direction of a light described with reference to FIGS. 4 through 6.

Accordingly, in a case where the optical pickup, according to an aspect of the present invention, uses the optical element 40, which is designed to carry out a proper function if necessary, the amount of the light power output from the light source 10 can be properly controlled using the monitor photodetector 45.

Because the optical pickup, according to an aspect of the present invention, includes the optical element 40 that is installed in front of the monitor photodetector 39 and adjusts at least one of the intensity, the beam profile, and the proceeding direction of incident light, the amount of the light power output from the light source can be controlled according to the conditions of the light source 10 using the monitor photodetector 45.

In particular, when the transmissivity of the optical element 40 varies according to the wavelength of incident light, both the amount of the light power for the CD and the amount of the light power for the DVD can be controlled using one monitor photodetector 45.

Moreover, in the event that the optical element 40 is formed so as to reduce the intensity of the incident light, even when the recording light power is increased for the high-speed recording, the light power output from the light source 10 can be properly controlled using the monitor photodetector 45.

Furthermore, if the beam profile of the light is adjusted, the intensity of the light received by the monitor photodetector 45 is not greatly affected even by the shifting or tilting of an optical component, particularly the light source 10, during the controlling of the high-speed recording. Therefore, the light power output from the amount of the light source can be properly controlled.

The optical pickup, according to an aspect of the present invention, can be used for recording data on and/or reproducing data from CD-family optical discs and/or DVD-family optical discs.

An optical pickup, according to an aspect of the present invention, is not limited to the above-described aspects and may be modified in various ways without departing from the spirit and scope of the present invention as defined by the following claims. For example, the optical pickup according to the present invention can include an optical element for adjusting a light in front of a monitor photodetector, and an entire optical structure thereof can be modified in various ways.

Although a few aspects of the present invention have been shown and described, it would be appreciated by those skilled in the art that changes may be made in this embodiment without departing from the principles and spirit of the invention, the scope of which is defined in the claims and their equivalents.

What is claimed is:

1. An optical pickup to focus a light emitted from a light source using an objective lens, forming a light spot on a recording surface of a recording medium, and performing recording and/or reproducing operations using the light, the optical pickup comprising:
a monitor photodetector; and
an optical element installed in front of the monitor photodetector to receive and to detect a portion of the light emitted from the light source to control an amount of light power output from the light source and to adjust at least one of an intensity, a beam profile, and a proceeding direction of the light incident on the monitor photodetector.

2. The optical pickup of claim 1, wherein the optical element is a holographic element.

3. The optical pickup of claim 2, wherein the optical element is formed to reduce the intensity of incident light.

4. The optical pickup of claim 2, wherein the light source comprises a plurality of light sources emitting light beams of different wavelengths, and a transmissivity of the optical element varies according to a wavelength of the incident light.

5. The optical pickup of claim 2, wherein the optical element adjusts divergence and convergence of incident light.

6. The optical pickup of claim 5, wherein the optical element shapes incident light.

7. The optical pickup of claim 2, wherein the optical element shapes incident light.

8. The optical pickup of claim 2, wherein the optical element adjusts a direction of a +1^{st}- or −1^{st}- order beam.

9. The optical pickup of claim 1, further comprising:
an optical path changing unit, wherein a portion of light emitted from the light source is split by the optical path changing unit, and proceeds toward the monitor photodetector.

10. The optical pickup of claim 9, wherein the optical path changing unit is one of a cubic beam splitter, a plate beam splitter, and a wedge beam splitter.

11. The optical pickup of claim 9, wherein the optical element forms a single body with the optical path changing unit or is separate from the optical path changing unit.

12. The optical pickup of claim 1, wherein the recording medium is a CD-family optical disc and/or a DVD-family optical disc.

13. An optical pickup for a recording medium, comprising:
a light source emitting light beams;
an objective lens focusing the light beams to form a light spot on a recording surface of the recording medium;
a main photodetector receiving the light beams reflected from the recording surface of the recording medium to detect a data signal and/or an error signal;
a monitor photodetector controlling an amount of light power output from the light source; and
an optical element controlling at least one of an intensity, a beam profile, and a proceeding direction of a light incident on the monitor photodetector.

14. The optical pickup of claim 13, wherein the optical element is in front of the monitor photodetector to receive and detect a portion of the light beams emitted from the light source to control the amount of the light power output from the light source and to adjust the light incident on the monitor photodetector.

15. The optical pickup of claim 13, wherein the light source comprises a single light source or two light sources that emit light beams having different wavelengths.

16. The optical pickup of claim 13, wherein the light source comprises a single light source that emits the light beams with a wavelength of 650 nm, where the optical pickup is used for DVDs.

17. The optical pickup of claim 13, wherein the light source comprises a single light source that emits the light beams with a wavelength of 780 nm, where the optical pickup is used to record data on and/or to reproduce the data from a CD.

18. The optical pickup of claim 13, wherein the light source comprises two light sources that emit the light beams with a wavelength of 780 nm for a CD and the light beams with a wavelength of 650 nm for a DVD, respectively, where the optical pickup is used to record data on and/or reproduce the data from the DVD and/or the CD.

19. The optical pickup of claim 13, wherein when the light source comprises two light sources, the optical pickup further comprises:
a light source module integrally comprising two light sources emitting the light beams having a 650 nm wavelength for a DVD and the light beams having a 780 nm wavelength for a CD, respectively.

20. The optical pickup of claim 13, further comprising:
an optical path changing unit allowing the light beams emitted from the light source to proceed toward the recording medium, changing optical paths of the light beams reflected from the recording medium so that the reflected light beams proceed toward the main photodetector, and splits a portion of light beams emitted from the light source so that split light beams proceed toward the monitor photodetector.

21. The optical pickup of claim 20, wherein the optical path changing unit comprises a cubic beam splitter, a plate beam splitter or a wedge beam splitter.

22. The optical pickup of claim 20, wherein when the optical path changing unit comprises a wedge beam splitter, the optical pickup further comprises:
a holographic optical module in which the light source and the main photodetector are modularised.

23. The optical pickup of claim 20, wherein the monitor photodetector is disposed at a side of the optical path changing unit so that the monitor photodetector receives and detects the portion of light beams emitted from the light source.

24. The optical pickup of claim 13, wherein the monitor photodetector outputs a detection signal, which drives the light source and is used to control the amount of the light power of the light source.

25. The optical pickup of claim 13, further comprising:
a collimating lens changing divergent light beams emitted from the light source into parallel light beams; and
a sensing lens enlarging a size of the light spot formed on the main photodetector.

26. The optical pickup of claim 13, wherein the light source comprises two light sources emitting the light beams having different wavelengths so that a transmissivity of the optical element is different for the light beams used for a CD and for the light beams used for a DVD.

27. The optical pickup of claim 13, wherein the light source comprises a plurality of light sources emitting light beams of different wavelengths, and a transmissivity of the optical element varies according to a wavelength of the light incident on the monitor photodetector.

28. The optical pickup of claim 13, wherein the optical element is installed between the optical path changing unit and the monitor photodetector to adjust an intensity of the light beams proceeding toward the monitor photodetector and to control the amount of the light power output from the light source during high-speed recording.
